(19) United States
(12) Patent Application Publication
(10) Pub. No.: US 2008/0317180 A1
(43) Pub. Date: Dec. 25, 2008

(54) RECEIVING APPARATUS CAPABLE OF REMOVING INTERFERENCE SIGNAL AND METHOD THEREOF

(75) Inventors: Ick-jin KWON, Yongin-si (KR); Jae-sup LEE, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/013,130

(22) Filed: Jan. 11, 2008

(30) Foreign Application Priority Data
Jun. 22, 2007 (KR) 10-2007-0061483

(51) Int. Cl. H04B 1/10

(52) U.S. Cl. 375/350

(57) ABSTRACT

An apparatus and method capable of interference signal removal is provided. The receiving apparatus includes a signal reception unit, a sampler which samples signal with carrier wave frequency, a signal filter, and a signal combiner.

### CROSS-REFERENCE TO RELATED APPLICATION

This application claims priority from Korean Patent Application No. 2007-0061483, filed Jun. 22, 2007 in the Korean Intellectual Property Office, the entire disclosure of which is hereby incorporated by reference.

### BACKGROUND OF THE INVENTION

1. Field of the Invention

Apparatuses and methods consistent with the present invention relate to interference signal removal, and more particularly, to an apparatus and a method capable of removing interference signal without using a radio frequency surface acoustic wave (RF SAW) filter, and a receiving method thereof.

2. Description of the Related Art

In most wireless communication systems, interference signals come along with the intended signal. Therefore, it is necessary to remove interference signals, because interference signals are usually bigger than the intended signals.

A radio frequency (RF) filter is generally used to remove interference signals. However, due to many difficulties in establishment and relatively poor performance of RF filter, another external filter such as surface acoustic wave (SAW) filter is used together to remove interference signals. A SAW filter is a communication filter that uses mechanical wave of piezoelectric electrode. Because a SAW filter has narrow bandwidth, it can effectively filter out unnecessary frequency signals. SAW filters are widely used in many areas, including, for example, RF or IF SAW filters for systems using intermediate frequency.

A related art method for removing interference signal will be explained below with reference to FIGS. 1 and 2.

Referring to FIG. 1A, a receiver includes a reception unit 11, a RF SAW filter 12, a low noise amplifier (LNA) 13, and an analog-to-digital converter (ADC) 16.

The reception unit 11 receives RF signals, which include interference signals therein. The reception unit 11 outputs RF signal to the RF SAW filter 12 to remove interference signal from the received RF signal.

The RF SAW filter 12 removes interference signal from the input signal, and transmits the signal to the LNA 13. The LNA 13 outputs signal to the ADC 16, where the signal is converted into digital form.

The receiver illustrated in FIG. 1B additionally has a sampler 14 and a discrete time reception unit 15, which are not provided to the receiver illustrated in FIG. 1A.

Signal past the LNA 13 is sampled in the sampler 14, passed through the discrete signal reception unit, and digitized by the ADC 16.

As explained above, the related art removes interference signal using RF SAW filter first, before receiving intended signals.

However, the above method using the RF SAW filter has problems.

That is, the requirement for an external SAW filter costs financially. Because the SAW filter itself is based on physical structure, it takes space considerably. Additionally, it costs much, because multi-band reception ends require external SAW filters respectively.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and a method for removing interference signal and extracting an intended signal efficiently, without using a SAW filter, when received signal contains interference signal therein.

According to an aspect of the present invention, there is provided a receiving apparatus, including a reception unit which receives a radio frequency (RF) signal containing an interference signal therein, a sampler which samples the RF signal received at the reception unit with a carrier wave frequency, to generate a discrete time signal, a filter which filters the discrete time signal, and a signal combiner which generates a combined signal, using the discrete time signal and filtered discrete time signal provided from the filter.

The filter may be a high pass filter (HPF).

The signal combiner may generate the combined signal by subtracting the filtered discrete time signal from the discrete time signal.

The receiving apparatus may further include an amplifier which amplifies the combined signal generated at the signal combiner.

The signal combiner may generate combined signal, using a delayed signal of the discrete time signal, and the filtered discrete time signal.

According to an aspect of the present invention, there is provided a receiving apparatus, including a reception unit which receives a radio frequency (RF) signal containing an interference signal therein, a sampler which samples the RF signal received at the reception unit with a carrier wave frequency, to generate a discrete time signal, a signal combiner which generates a combined signal, using the discrete time signal and an input signal, and a filter which filters the combined signal generated at the signal combiner, and which applies the filtered signal as the input signal to the signal combiner.

The filter may filter an amplified signal of the combined signal, and apply the filtered signal as the input signal to the signal combiner.

According to an aspect of the present invention, there is provided a receiving method, including receiving a radio frequency (RF) signal containing an interference signal therein, sampling the RF signal received at the reception unit with a carrier wave frequency, to generate a discrete time signal, and generating a combined signal, using the discrete time signal and filtered discrete time signal provided from the filter.

The filtered discrete time signal may be processed by high pass filtering.

According to an aspect of the present invention, there is provided a receiving apparatus, including a reception unit which receives a radio frequency (RF) signal containing an interference signal therein, a first sampler which samples an I-component of the RF signal received at the reception unit with a carrier wave frequency, to generate a first discrete time signal, a first filter which filters the first discrete time signal, a first signal combiner which generates a first combined signal, using the first discrete time signal and a filtered first discrete time signal from the first filter, a first converter which converts the first combined signal into a digital signal, a second sampler which samples a Q-component of the RF signal received at the reception unit, to generate a second discrete time signal, a second filter which filters the second discrete time signal, a second signal combiner which generates a second combined signal, using the second discrete time signal and a filtered second discrete time signal from the second filter, a second converter which converts the second combined signal into a digital signal, and a signal synthesis unit which combines the converted first combined signal with the combined second combined signal.

### BRIEF DESCRIPTION OF THE DRAWINGS

The above and other aspects of the present invention will be more apparent from the following detailed description of exemplary embodiments with reference to the accompanying drawings, in which:

FIGS. 1A and 1B illustrate a related art apparatus for removing interference signals;

FIG. 2 is a block diagram of a receiving apparatus capable of interference removal, according to an exemplary embodiment of the present invention;

FIGS. 3A to 3D illustrate a process of removing interferences at the receiving apparatus capable of interference removal according to an exemplary embodiment of the present invention;

FIG. 4 is a block diagram of a receiving apparatus capable of interference removal according to another exemplary embodiment of the present invention;

FIG. 5 is a block diagram of a receiving apparatus capable of interference removal according to another exemplary embodiment of the present invention;

FIG. 6 is a block diagram of a receiving apparatus capable of interference removal according to yet another exemplary embodiment of the present invention;

FIG. 7 is a block diagram of a receiving apparatus capable of interference removal according to yet another exemplary embodiment of the present invention;

FIG. 8 is a block diagram of a receiving apparatus capable of interference removal according to yet another exemplary embodiment of the present invention;

FIG. 9 is a block diagram of a receiving apparatus capable of interference removal according to yet another exemplary embodiment of the present invention; and

FIG. 10 is a block diagram of a receiving apparatus capable of interference removal according to yet another exemplary embodiment of the present invention.

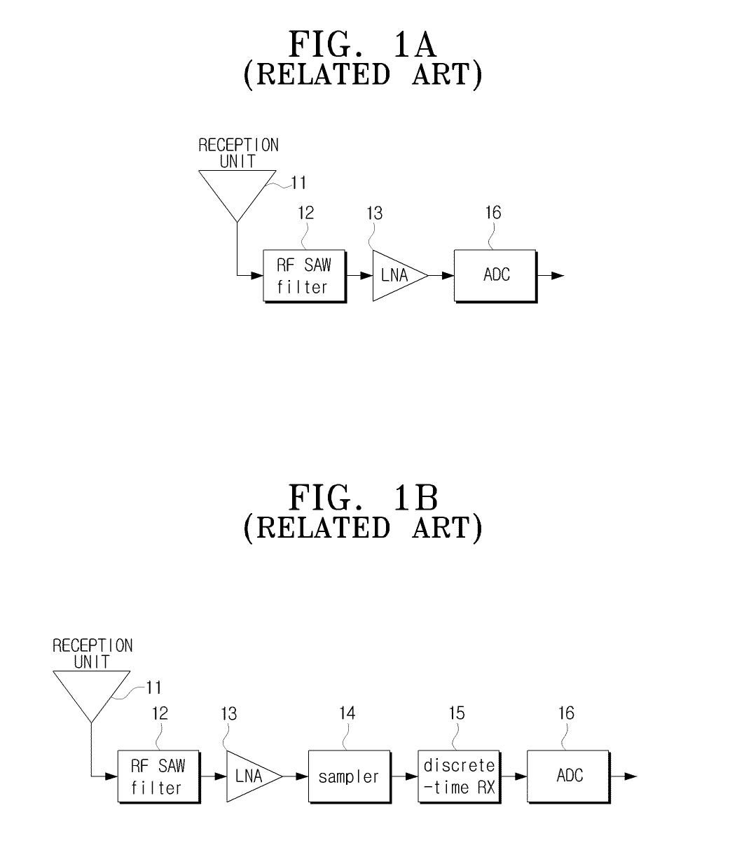

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

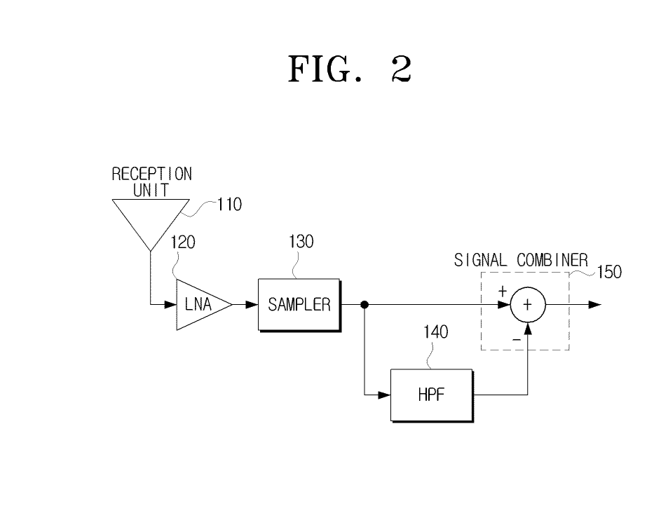

Referring to FIG. 2, a receiving apparatus according to an exemplary embodiment of the present invention includes a reception unit 110, a low noise amplifier (LNA) 120, a sampler 130, a high pass filter (HPF) 140, and a signal combiner 150.

The reception unit 110 receives RF signals, including interference signals contained in the RF signals. The reception unit 110 transmits the received RF signals to the LNA 120.

The LNA 120 receives RF signal containing interference signal therein, and amplifies the received signal. Because the signal received at the reception unit 110 has a relatively low power level due to offset and noise, amplifying process is necessary. However, because the received signal is already laden with external noises, the amplifying process needs to minimize the noise most of all. The LNA 120 is designed based on the operating point and matching point where there is low noise factor (NF). The LNA 120 amplifies the RF signal and outputs it to the sampler 130.

The sampler 130 samples in RF band the amplified signal being received from the LNA 120. Intended signal is down-converted to baseband, as the amplified signal is sampled with carrier wave frequency. At this time, not only the intended signal, but also the interference signal is down-converted. After sampling, signal repeats in every sampling frequency (fₛ), and it becomes discrete time signal.

Frequency conversion may be carried out twice, while the carrier wave frequency is converted to baseband. Intermediate frequency (IF) is formed between the carrier wave and baseband. HPF 140 may be achieved easily, and better selectivity is provided, by the two times of conversion using intermediate frequency.

After sampling at the sampler 130, discrete time signal is output and input to the HPF 140 and the signal combiner 150.

As the HPF 140 receives signal from the sampler 130, the HPF 140 performs filtering and outputs the resultant signal to the signal combiner 150. The HPF 140 removes intended signal, and passes interference signal only.

The signal combiner 150 combines discrete time signal being output from the sampler 130 with discrete time signal being output from the HPF 140 and being filtered, to generate a combined signal. The signal combiner 150 generates a combined signal, by subtracting filtered discrete time signal from the discrete time signal.

As explained above, the receiving apparatus according to the exemplary embodiment of the present invention is capable of receiving only the signals intended by the user, by subtracting the filtered discrete time signal, thereby leaving the interference signal alone. As a result, a receiving end can receive intended signal only.

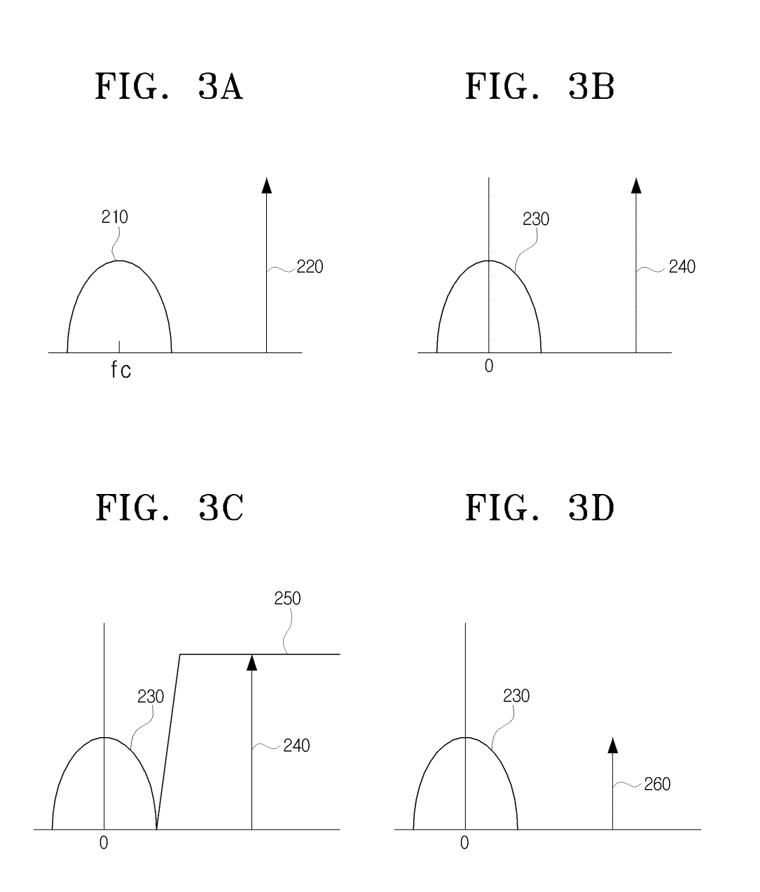

FIGS. 3A to 3D are provided to explain the process of removing interferences at the receiving apparatus according to an exemplary embodiment of the present invention.

FIG. 3A illustrates a signal being received at the reception unit. The received signal includes an intended signal 210, and an interference signal 220.

FIG. 3B illustrates a signal being output from the sampler 130. That is, FIG. 3B shows the signal 230 down-converted to baseband, along with the interference signal 240 which is also down-converted.

FIG. 3C illustrates a discrete signal from the sampler 130 being processed into high pass filtered signal 250. A discrete signal includes an intended signal 230, and an interference signal 240. The filter disposes the intended signal 230, and takes interference signal 240 only.

FIG. 3D illustrates a resultant signal being obtained after the subtraction of signal of FIG. 3C from signal of FIG. 3B. That is, the subtraction uses discrete signal being output from the sampler 130, and filtered discrete signal being output from the HPF 140. Accordingly, interference signal is reduced, by subtracting the filtered discrete signal from the discrete signal.

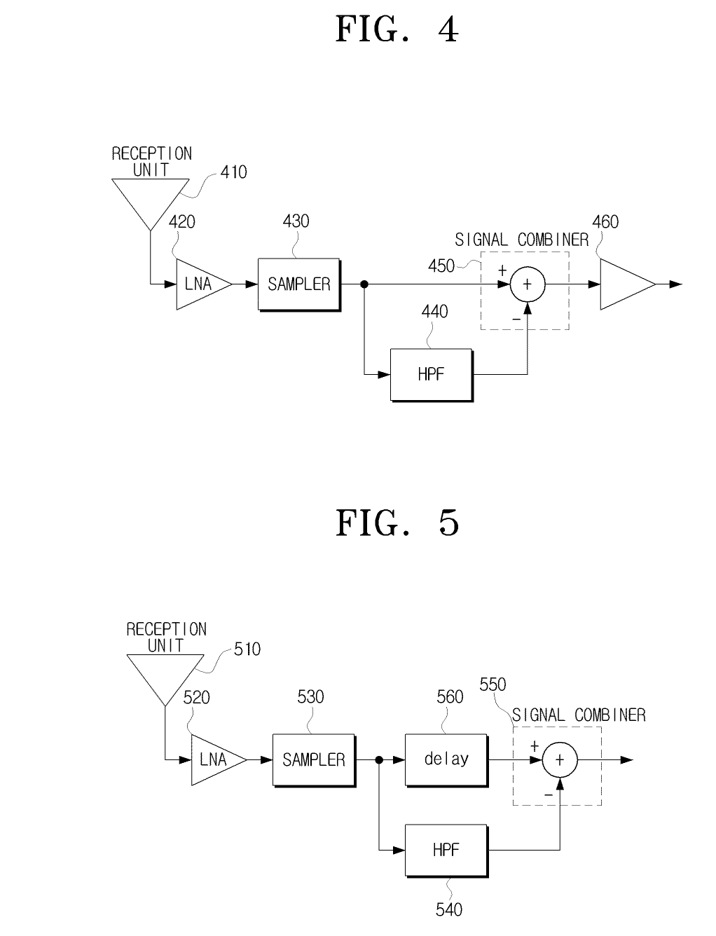

FIG. 4 is a block diagram of a receiving apparatus capable of interference removal according to another exemplary embodiment of the present invention. Referring to FIG. 4, the receiving apparatus according to another exemplary embodiment includes a reception unit 410, a LNA 420, a sampler 430, a HPF 440, a signal combiner 450, and an amplifier 460. The reception unit 410, the LNA 420, the sampler 430, the HPF 440, and the signal combiner 450 have the same functions as those 110, 120, 130, 140, 150 illustrated in FIG. 2. Therefore, the detailed explanation of the overlapping elements or operations will be omitted for the sake of brevity.

The amplifier 460 amplifies the signal received from the signal combiner 450. That is, the signal combiner 450 reduces interference signal, thus enabling reception of intended signal only. In this situation, the amplifier 460 amplifies the intended signal, if the intended signal is not large enough.

FIG. 5 is a block diagram of a receiving apparatus capable of interference removal according to yet another exemplary embodiment of the present invention.

Referring to FIG. 5, the receiving apparatus according to yet another exemplary embodiment includes a reception unit 510, a LNA 520, a sampler 530, a HPF 540, a signal combiner 550, and a delayer 560. The reception 510, the LNA 520, the sampler 530, the HPF 540, and the signal combiner 550 have the same functions as those 110, 120, 130, 140, 150 illustrated in FIG. 2.

The delayer 560 delays a discrete time signal being output from the sampler 530 by a predetermined time interval. The signal combiner 550 extracts intended signal, by computing the discrete time signal being output from the sampler 530, and the filtered discrete signal being output from the sampler 530 and then the HPF 540. In this process, signal output from the HPF 540 is likely to be delayed. Accordingly, the delayer 560 delays the discrete time signal for the duration of time that corresponds to the delay time of the signal past the HPF 540. The signal combiner 550 computes the signal output from the delayer 560 and the signal output from the HPF 540, to extract intended signal.

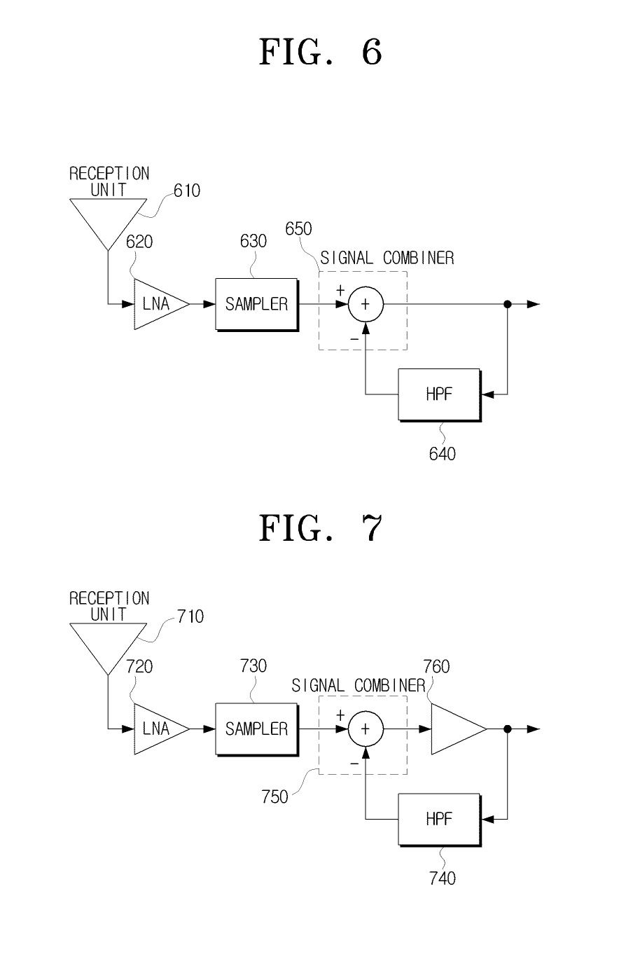

FIG. 6 is a block diagram of a receiving apparatus capable of interference removal according to yet another exemplary embodiment of the present invention.

Referring to FIG. 6, the receiving apparatus implements a feedback circuit, which includes a reception unit 610, a LNA 620, a sampler 630, a HPF 640 and a signal combiner 650. The reception unit 610, the LNA 620, and the sampler 630 have the same functions as those 110, 120, 130 illustrated in FIG. 2.

The signal combiner 650 generates a combined signal, using discrete signal, which is one type of sampled signal, and an input signal. The combined signal is output from the signal combiner 650, and also feedbacked for the filtering at the HPF 640. The filtered signal from the HPF 640 is input to the signal combiner 650. Therefore, The filtered signal is used as the input signal, which will be passed through the signal combiner 650 and input again in a feedback structure.

FIG. 7 is a block diagram of a receiving apparatus capable of interference removal according to yet another exemplary embodiment of the present invention.

Referring to FIG. 7, the receiving apparatus implements a feedback circuit, which includes a reception unit 710, a LNA 720, a sampler 730, a HPF 740, a signal combiner 750, and an amplifier 760. The reception unit 710, the LNA 720, and the sampler 730 have the same functions as those 110, 120, 130 illustrated in FIG. 2.

The signal combiner 750 generates a combined signal, using discrete time signal, which is one type of sampled signal, and an input signal. The combined signal generated at the signal combiner 750 is input to the amplifier 760. The amplified signal of the amplifier 760 is transported to the outside, and also feedbacked for the filtering at the HPF 740. The filtered signal from the HPF 740 is input to the signal combiner 750. Therefore, The filtered signal is used as the input signal, which will be passed through the signal combiner 750 and input again in a feedback structure.

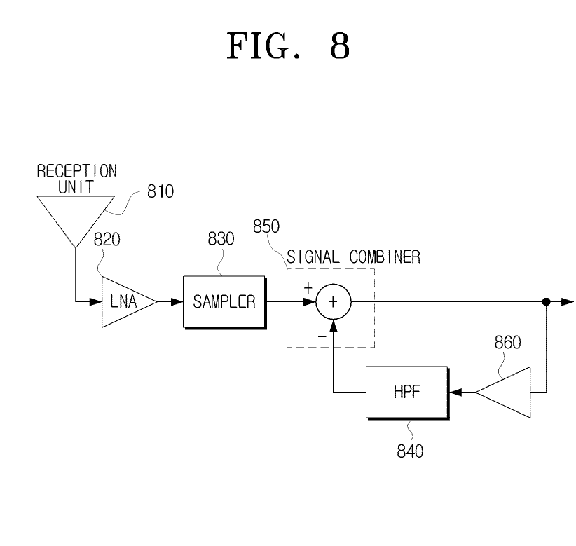

FIG. 8 is a block diagram of a receiving apparatus capable of interference removal according to yet another exemplary embodiment of the present invention.

Referring to FIG. 8, the receiving apparatus implements a feedback circuit, which includes a reception unit 810, a LNA 820, a sampler 830, a HPF 840, a signal combiner 850, and an amplifier 860. The reception unit 810, the LNA 820, and the sampler 830 have the same functions as those 110, 120, 130 illustrated in FIG. 2.

The signal combiner 850 generates a combined signal, using discrete time signal, which is one type of sampled signal, and an input signal. The combined signal generated at the signal combiner 850 is transported to the outside, and also feedbacked to the amplifier 860. The signal output from the amplifier 860 is filtered at the HPF 840. The filtered signal from the HPF 840 is input to the signal combiner 850. Therefore, The filtered signal is used as the input signal, which will be passed through the signal combiner 850 and input again in a feedback structure.

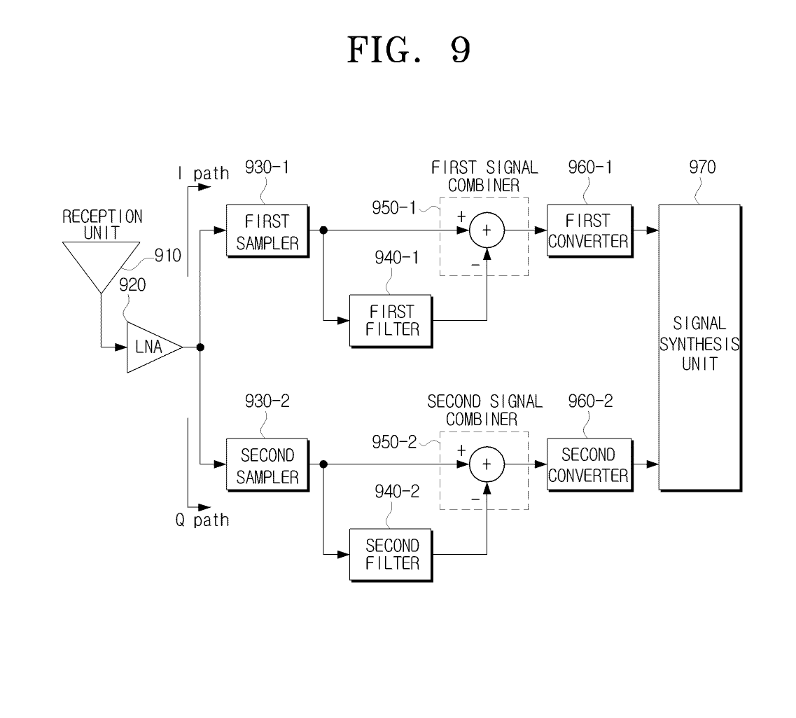

FIG. 9 is a block diagram of a receiving apparatus capable of interference removal according to yet another exemplary embodiment of the present invention.

Referring to FIG. 9, the receiving apparatus according to yet another exemplary embodiment includes a reception unit 910, a LNA 920, a first sampler 930-1, a second sampler 930-2, a first filter 940-1, a second filter 940-2, a first signal combiner 950-1, a second signal combiner 950-2, a first converter 960-1, a second converter 960-2, and a signal synthesis unit 970. The reception unit 910 and the LNA 920 have the same function as those 110, 120 illustrated in FIG. 2.

A RF signal is output from the LNA 920, and divided into I-component and Q-component, which are passed through I-path and Q-path and input to the first and second samplers 930-1, 930-2, respectively.

The first sampler 930-1 samples I-component of RF signal with carrier wave frequency, to generate a first discrete time signal.

The first filter 940-1 filters the first discrete time signal and outputs the resultant signal to the first signal combiner 950-1. The first signal combiner 950-1 generates a first combined signal, using the first discrete time signal, and the HPF-ed first discrete time signal from the first filter 940-1.

The first converter 960-1 converts the first combined signal into digital signal, and outputs the resultant signal to the signal synthesis unit 970.

The second sampler 930-2 samples Q-component of RF signal with carrier wave frequency, and generates a second discrete time signal.

The second filter 940-2 filters the second discrete time signal by high pass filtering, and outputs the resultant signal to the second signal combiner 950-2. The second signal combiner 950-2 generates a second combined signal, using the second discrete signal, and the HPF-ed second discrete time signal from the second filter.

The second converter 960-2 converts the second combined signal into digital signal, and outputs the resultant signal to the signal synthesis unit 970.

The signal synthesis unit 970 combines the converted first combined signal and the converted second combined signal, and transports a desired signal to user.

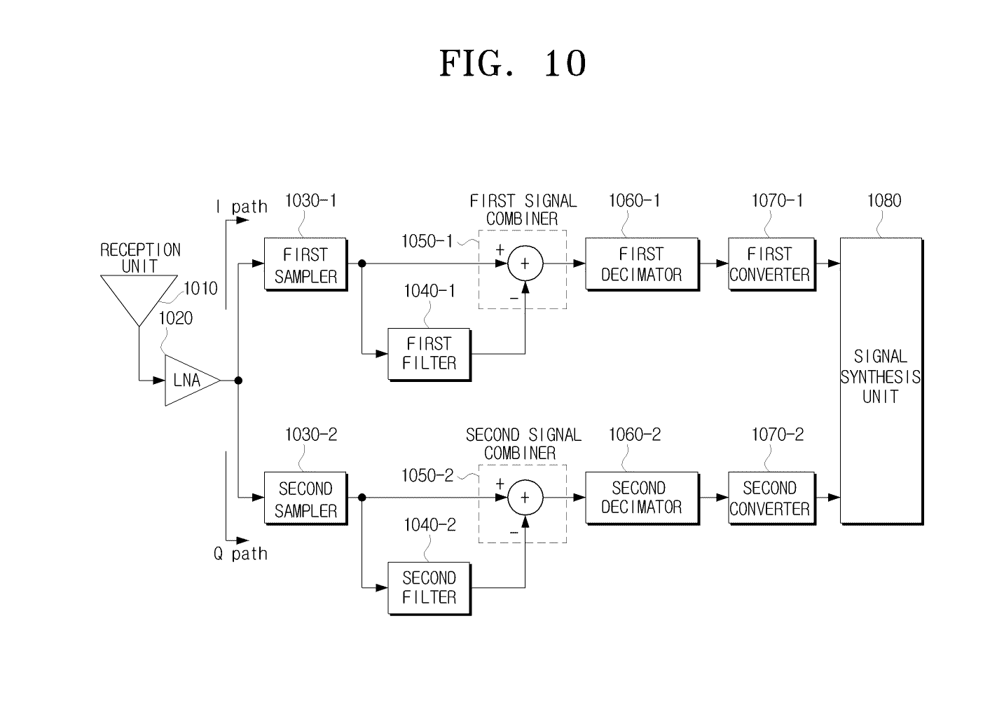

FIG. 10 is a block diagram of a receiving apparatus capable of interference removal according to yet another exemplary embodiment of the present invention.

Referring to FIG. 10, the receiving apparatus according to yet another exemplary embodiment includes a reception unit 1010, a LNA 1020, a first sampler 1030-1, a second sampler 1030-2, a first filter 1040-1, a second filter 1040-2, a first signal combiner 1050-1, a second signal combiner 1050-2, a first converter 1070-1, a second converter 1070-2, and a signal synthesis unit 1080. The reception unit 1010, the LNA 1020, the first sampler 1030-1, the second sampler 1030-2, the first filter 1040-1, the second filter 1040-2, the first signal combiner 1050-1, the second signal combiner 1050-2, the first converter 1070-1, the second converter 1070-2, and the signal synthesis unit 1080 have the same functions as those 910, 920, 930-1, 930-2, 940-1, 940-2, 950-1, 950-2, 960-1, 960-2, 970 illustrated in FIG. 10.

The first decimator 1060-1 receives a combined signal from the first signal combiner 1050-1, lowers operating frequency, and outputs the resultant signal to the first converter 1070-1.

The first converter 1070-1 receives the combined signal with lowered operating frequency, converts the signal into digital signal, and outputs the resultant signal to the signal synthesis unit 1080.

The second decimator 1060-2 receives a combined signal from the second signal combiner 1050-2, lowers operating frequency, and outputs the resultant signal to the second converter 1070-2.

The second converter 1070-2 receives the combined signal with the lowered operating frequency, converts the signal into digital signal, and outputs the resultant signal to the signal synthesis unit 1080.

The signal synthesis unit 1080 combines the signals being digitized at the first and second converters 1070-1, 1070-2, to generate a signal as desired by user.

According to the exemplary embodiments of the present invention explained above, improved interference removal effect, far better than RF filter, is provided, by using high pass filter provided in baseband. Better signal conversion is also provided, by removing interference signal during digitization of signal. Furthermore, good cost efficiency and space utilization is provided because component such as SAW filter is omitted. Still higher cost and space efficiency is expected particularly in multi-band implementation, because it is unnecessary to provide the multi bands with separate SAW filters anymore.

While certain exemplary embodiments of the present invention have been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. A receiving apparatus, comprising:
a reception unit which receives a radio frequency (RF) signal containing an interference signal therein;
a sampler which samples the RF signal received at the reception unit with a carrier wave frequency, to generate a discrete time signal;
a filter which filters the discrete time signal; and
a signal combiner which generates a combined signal, using the discrete time signal and filtered discrete time signal provided from the filter.

2. The receiving apparatus of claim 1, wherein the filter comprises a high pass filter (HPF).

3. The receiving apparatus of claim 1, wherein the signal combiner generates the combined signal by subtracting the filtered discrete time signal from the discrete time signal.

4. The receiving apparatus of claim 1, further comprising an amplifier which amplifies the combined signal generated at the signal combiner.

5. The receiving apparatus of claim 1, wherein the signal combiner generates combined signal, using a delayed signal of the discrete time signal, and the filtered discrete time signal.

6. A receiving apparatus, comprising:
a reception unit which receives a radio frequency (RF) signal containing an interference signal therein;
a sampler which samples the RF signal received at the reception unit with a carrier wave frequency, to generate a discrete time signal;
a signal combiner which generates a combined signal, using the discrete time signal and an input signal; and
a filter which filters the combined signal generated at the signal combiner, and which applies the filtered signal as the input signal to the signal combiner.

7. The receiving apparatus of claim 6, wherein the filter filters an amplified signal of the combined signal, and applies the filtered signal as the input signal to the signal combiner.

8. A receiving method, comprising:
receiving a radio frequency (RF) signal containing an interference signal therein;
sampling the RF signal received at the reception unit with a carrier wave frequency, to generate a discrete time signal; and
generating a combined signal, using the discrete time signal and filtered discrete time signal provided from the filter.

9. The receiving method of claim 8, wherein the filtered discrete time signal is processed by high pass filtering.

10. A receiving apparatus, comprising:
a reception unit which receives a radio frequency (RF) signal containing an interference signal therein;
a first sampler which samples an I-component of the RF signal received at the reception unit with a carrier wave frequency, to generate a first discrete time signal;
a first filter which filters the first discrete time signal;
a first signal combiner which generates a first combined signal, using the first discrete time signal and a filtered first discrete time signal from the first filter;
a first converter which converts the first combined signal into a digital signal;
a second sampler which samples a Q-component of the RF signal received at the reception unit, to generate a second discrete time signal;
a second filter which filters the second discrete time signal;
a second signal combiner which generates a second combined signal, using the second discrete time signal and a filtered second discrete time signal from the second filter;
a second converter which converts the second combined signal into a digital signal; and
a signal synthesis unit which combines the converted first combined signal with the combined second combined signal.
